(19) United States
(12) Patent Application Publication
(10) Pub. No.: US 2017/0088709 A1
(43) Pub. Date: Mar. 30, 2017

(54) BIO-ALLOY COMPOSITIONS

(71) Applicant: Aspen Research Corporation, Maple Grove, MN (US)

(72) Inventors: Kenneth Wyatt Richards, Plymouth, MN (US); Nathan Thomas Koenig, Minneapolis, MN (US); Andrew Haugen, Bloomington, MN (US); Christopher James Chapman, Brooklyn Center, MN (US); Kenneth Daniel Zigrino, Eden Prairie, MN (US)

(73) Assignee: Aspen Research Corporation, Maple Grove, MN (US)

(21) Appl. No.: 15/280,097

(22) Filed: Sep. 29, 2016

Related U.S. Application Data
(60) Provisional application No. 62/235,089, filed on Sep. 30, 2015.

(51) Int. Cl. C08L 67/04

(52) U.S. Cl. CPC C08L 67/04; C08L 2205/03

(57) ABSTRACT

Bio-alloy compositions, having improved mechanical, physical and thermal comprising at least one petroleum-based polymer and at least one biopolymer. Furthermore, the present disclosure relates generally to polymer compositions comprising a bio-alloy having improved characteristics, the bio-alloy including at least one hybrid biopolymer having same molecular structure as that of a petroleum based polymer and at least one biopolymer.

### CROSS-REFERENCE TO RELATED APPLICATIONS

This application claims priority to U.S. Provisional Patent Application No. 62/235,089 filed Sep. 30, 2016.

### BACKGROUND OF THE INVENTION

The present disclosure relates generally to polymer compositions comprising a bio-alloy having improved characteristics, the bio-alloy including at least one petroleum-based polymer and at least one biopolymer. Furthermore, the present disclosure relates generally to polymer compositions comprising a bio-alloy having improved characteristics, the bio-alloy including at least one hybrid biopolymer having same molecular structure as that of a petroleum based polymer and at least one biopolymer.

Petroleum-based polymers such as acrylics, styrenes, polycarbonate and ABS are produced by various resin manufacturers each producing various grades of a polymeric material also having different physical properties. The manufacturing may vary from manufacturer to manufacturer resulting in varying amounts of impurities and differences in quality between polymers of similar grade from one manufacturer to the next.

These differences in manufacturing processes may result in varying degrees of free monomers, dimers and other oligomers present in the resin. For example, polymethyl methacrylate (PMMA) polymeric backbone is derived primarily from polymerization of methyl methacrylate monomer (MMA) and to a lesser degree, methacrylate (MA) monomer. However, the PMMA resin resulting from the polymerization may also include, depending on the process used by the manufacturer for the production of the PMMA, varying degrees of un-polymerized or “free” MMA and MA monomers as well as other free dimers and oligomers, all of which may negatively impact quality as well as the economics of the commercial polymer.

The presence of the free monomers, dimers and other oligomers in a petroleum-based polymer resin, for example an acrylic resin, may vary in degree between manufacturers for similar grades of the same material as a result of differences in the polymerization processes employed.

Biopolymers, like petroleum-based polymers, are produced by various manufactures and include various grades having different properties. Biopolymers include for example, polyhydroxyalkanoic acid (PHAA) based polymers such as polyhydroxy butyrate (PHB), polyhydroxy valerate (PHV) and poly(hydroxybutyrate-hydroxy valerate) copolymers, polylactic acid (PLA) based polymers, polyglycolic acid based polymers (PGA), polylactide-co-glycolide, etc. These polymers also have varying color and clarity attributes which restricts their use in articles where better clarity and less haze is required.

NatureWorks LLC, a manufacturer of PLA, produces both amorphous PLA and grades of PLA having varying degree of crystallinity which impacts heat deflection temperature. PLA, including those produced by NatureWorks, LLC exhibit a yellowish tint and haze that may further vary from lot to lot within the same grade.

Residual free monomers left in the polymerized petroleum-based polymer resins may negatively interact with PLA and other biopolymers when compounding a bio-alloy causing post processing issues as well as poor physical, thermal, mechanical, and optical properties.

The present invention provides bio-alloy compositions wherein the impact of free monomers, dimers, other oligomers and moisture from the petroleum-based polymers and biopolymers have been mitigated, resulting in improved physical properties, improved perceived clarity and improved color attributes for the production of articles.

### SUMMARY OF THE INVENTION

In one aspect, the present invention relates to a polymer composition of at least one bio-alloy comprised of at least one biopolymer with reduced free dimers and other oligomers and at least one petroleum-based polymer having reduced free monomers, dimers and other oligomers.

In one aspect, the present invention relates to a polymer composition comprising about 100% by weight of at least one bio-alloy, the bio-alloy comprising about 25% to about 75% by weight of at least one amorphous biopolymer and about 75% to about 25% by weight of at least one petroleum-based polymer.

In one aspect, the present invention relates to a polymer composition comprising about 100% by weight of at least one bio-alloy, the bio-alloy comprising about 25% to about 75% by weight of at least one crystalline biopolymer and about 75% to about 25% by weight of at least one petroleum-based polymer.

In one aspect, the present invention relates to a polymer composition comprising about 100% by weight of at least one bio-alloy, the bio-alloy comprising about 25% to about 75% by weight of at least one amorphous biopolymer and about 75% to about 25% by weight of at least one hybrid biopolymer.

In another aspect, the present invention relates to a perceived clear polymer composition comprising about 100% by weight of at least one bio-alloy, the bio-alloy comprising about 25% to about 75% by weight of at least one amorphous polylactic acid based biopolymer, about 75% to about 25% by weight of at least one polymethyl (meth)acrylate petroleum-based polymer and about 0.0001% to about 0.002% of at least one optical additive.

In another aspect, the present invention relates to a perceived clear polymer composition comprising about 100% by weight of at least one bio-alloy, the bio-alloy comprising about 25% to about 75% by weight of at least one amorphous polylactic acid based biopolymer, about 75% to about 25% by weight of at least one hybrid biopolymer having same molecular structure as polymethyl (meth)acrylate petroleum-based polymer and about 0.0001% to about 0.002% of at least one optical additive.

In another aspect, the present invention relates to a perceived clear polymer composition comprising about 100% by weight of at least one bio-alloy, the bio-alloy comprising about 25% to about 75% by weight of at least one amorphous polylactic acid based biopolymer, about 75% to about 25% by weight of at least one polymethyl (meth)acrylate petroleum-based polymer about 0.5% to about 15% of at least one impact modifier, and about 0.0001% to about 0.002% of at least one optical additive.

In another aspect, the present invention relates to a perceived clear polymer composition comprising about 100% by weight of at least one bio-alloy, the bio-alloy comprising about 25% to about 75% by weight of at least one amorphous polylactic acid based biopolymer, about 75% to about 25% by weight of at least one hybrid biopolymer having same molecular structure as polymethyl (meth)acrylate petroleum-based polymer about 0.5% to about 15% of at least one impact modifier, and about 0.0001% to about 0.002% of at least one optical additive.

In another aspect, the present invention relates to a polymer composition comprising about 100% by weight of at least one bio-alloy, the bio-alloy comprising about 25% to about 75% by weight of at least one crystalline polylactic acid based biopolymer, about 75% to about 25% by weight of at least one polymethyl (meth)acrylate petroleum-based polymer about 0.5% to about 15% of at least one impact modifier which may further be composed of a one or more nucleating agents.

In another aspect, the present invention relates to a polymer composition comprising about 100% by weight of at least one bio-alloy, the bio-alloy comprising about 25% to about 75% by weight of at least one crystalline polylactic acid based biopolymer, about 75% to about 25% by weight of at least one hybrid biopolymer having same molecular structure as polymethyl (meth)acrylate petroleum-based polymer about 0.50% to about 15% of an impact modifier which may further be composed of a one or more nucleating agents.

In another aspect, the present invention relates to a polymer composition comprising about 100% by weight of at least one bio-alloy, the bio-alloy comprising about 25% to about 75% by weight of at least one amorphous or crystalline polylactic acid based biopolymer, about 75% to about 25% by weight of at least one Acrylonitrile butadiene styrene (ABS) petroleum-based polymer and about 0.50% to about 15% of at least impact modifier.

In another aspect, the present invention relates to a polymer composition comprising about 100% by weight of at least one bio-alloy, the bio-alloy comprising about 25% to about 75% by weight of at least one amorphous or crystalline polylactic acid based biopolymer, about 75% to about 25% by weight of at least one hybrid bio polymer having same molecular structure as a polyester petroleum-based polymer and about 0.50% to about 15% of at least impact modifier.

In another aspect, the present invention is compounded on a co-rotating, intermeshing twin screw compounding extruder.

The resultant compounded bio-alloy may be used for the making of articles utilizing various means known to the industry, including, without limitation, injection molding, extrusion, compression, roto-molding, blow molding and 3D printing.

### DETAILED DESCRIPTION

While embodiments of the present disclosure may take many forms, there are described in detail herein specific embodiments of the present disclosure. This description is an exemplification of the principles of the present disclosure and is not intended to limit the disclosure to the particular embodiments illustrated.

In the following detailed description, reference is made to the accompanying examples, which form a part hereof, and in which are shown, by way of example, specific embodiments of the compositions that may be produced as described herein and specific embodiments in which the methods and systems described herein may be practiced. These embodiments are described in sufficient detail to enable those skilled in the art to produce the described compositions and practice the described processes and methods, and it is to be understood that the embodiments may be combined or used separately, or that other embodiments may be used, and that formulae, design, implementation, and procedural changes may be made without departing from the spirit and scope of the compositions, methods and processes described herein.

The term “bio-alloy” as used herein refers to a polymeric material including at least one petroleum-based polymer and at least one biopolymer and may further include one or more other additives, including, without limitation, optical additives.

The term “biopolymer” as used herein is defined as any polymer that is not a petroleum-based polymer, and includes but is not limited to alloys, blends, combinations or mixtures of two or more biopolymers as well as copolymers, terpolymers etc. formed from one or more biopolymers.

The term “hybrid biopolymer” as used herein is defined as any polymer that is of the same molecular structure as a petroleum-based polymer derived from sugar, starch, cellulosic or other bio based feedstocks

Examples of suitable biopolymers include but are not limited to, polyhydroxyalkanoic acids (PHAA) based polymers such as polyhydroxyalkanoic acid (PHA), polyhydroxy butyrate (PHB), polyhydroxy valerate (PHV) and poly(hydroxybutyrate-hydroxy valerate) copolymers, polylactic acid (PLA) based polymers, polyglycolic acid based polymers (PGA), polylactide-co-glycolide, and other polyesters including, for example, polybutylene succinic acid (PBS).

The term “petroleum-based polymer” as used herein is defined as a synthetically polymerized resin formed from petroleum, petroleum by-products, petroleum-derived monomers or petroleum-derived feedstocks and includes but is not limited to alloys, blends, combinations or mixtures of two or more petroleum-based polymers as well as co-polymers, terpolymers etc. formed from one or more petroleum-based polymers.

Examples of suitable petroleum-based polymers include, but are not limited to, polycarbonates, acrylic acid-based polymers such as polymethyl methacrylate (PMMA), polyalkyl(meth) acrylates, styrene and copolymers and terpolymers thereof, Acrylonitrile butadiene styrene (ABS), polyolefins, including polypropylene and polyethylene as well as copolymers and terpolymers thereof, and so forth.

The term “optical additive” as used herein, may refer to any additive that alters the “perceived clarity” of the polymer material wherein to the human eye, it is perceived to be clear, nearly clear or clearer, even if there is a light tint of color, than the same polymer material without the optical additive.

In some embodiments, the perceived clarity may result from the change in the L*a*b* color space of the material by addition of a color additive, a reduction of haze, an increase of light transmission, etc.

In some embodiments, a shift in color may be detectable using the L,a,b color space with dimension L for brightness and “a” and “b” for the color-opponent dimensions. The three coordinates of Lab represent the lightness of the color for the L coordinate wherein a value of 0 yields black and a value of 100 indicates diffuse white, for the a coordinate negative values indicate green and positive values indicate magenta, and for the b coordinate negative values indicate blue and positive values indicate yellow.

More particularly, the shift may be from yellow to blue on the Lab scale.

The term “optical additive” as used herein is inclusive of and may be used interchangeably with “color additive,” and is defined as any dye or other organic and inorganic substance, used to change the L,a,b color space or other properties of a compounded bio-alloy such that the perceived color of the compounded bio-alloy shifts from a yellow or other color tint to a perceived higher clarity. Examples of optical additives include Keyplast part number Violet IRS and PLA master batch clear, Color No: 0M51642462 manufactured by Clariant.

The term “master batch” as used herein is defined as a polymeric material compounded to a specific concentration of optical and/or other additives with a biopolymer or petroleum-based polymer, preferably the biopolymer, which compounded polymeric material is then further let-down at desired ratios with other polymeric inputs.

The term “let down” as used herein is defined as the process and technique of taking a master batch and adding to it one or more additional polymeric materials and/or additives to achieve a pre-determined ratio of inputs for a targeted resin composition.

The term “volatiles” means the free monomers, dimers, oligomers, moisture and other substances contained in a polymeric material.

In one aspect, the present invention relates to polymer compositions comprising a bio-alloy having improved and more predictable physical and optical characteristics, including, without limitation, improved perceived clarity, as compared to polymer compositions comprising bio-alloys made from the same input materials wherein free monomers, dimers, oligomers and moisture have not been comparably reduced or removed.

The embodiments of the compositions comprising bio-alloys which exhibit improved post compounding processing such as but not limited to injection molding or extrusion of articles having improved mechanical, physical, thermal properties and optical properties when applicable.

In some embodiments, the at least one biopolymer may be comprised of a blend of biopolymers.

In some embodiments, the at least one biopolymer may be comprised of a blend of bio-polymers that may include about 4% to 96% by weight of a first biopolymer and about 96% to about 4% by weight of a second biopolymer.

In some embodiments, the second biopolymer may be added as an impact modifier. In such embodiments, the second biopolymer suitably has a glass transition temperature that is lower than that of the first biopolymer.

In some embodiments, the at least one petroleum-based polymer may be comprised of a blend of petroleum-based polymers.

In some embodiments, the at least one petroleum-based polymer may be comprised of a blend of petroleum-based polymers that may include about 5% to 95% by weight of a first petroleum-based polymer and about 95% to about 5% by weight of a second petroleum-based polymer.

In one aspect, the present invention relates to polymer compositions comprising a bio-alloy having improved and more predictable physical and optical characteristics, including, without limitation, improved perceived clarity and higher heat deflection temperature, as compared to polymer compositions comprising bio-alloys made from the same input materials but from which free monomers, dimers, oligomers and moisture have not been comparably reduced or removed.

The embodiments of the compositions comprising bio-alloys which exhibit improved post compounding processing such as but not limited to injection molding or extrusion of articles having improved mechanical, physical, thermal properties and improved optical properties where clarity and haze are applicable.

In some embodiments, the at least one biopolymer may be comprised of a blend of biopolymers.

In one embodiment a composition wherein the free monomers, dimers and oligomers of the polymeric inputs are substantially reduced by devolatization.

In one embodiment a composition of at least one petroleum and one bio-based polymer where the free monomers, dimers and oligomers of the petroleum and bio polymers are substantially reduced by devolatization.

In one embodiment a perceived clear polymer composition comprising about 100% by weight of at least one bio-alloy, the bio-alloy comprising of at least one petroleum polymer of 25% to 75% by weight, at least one amorphous bio-based polymer of 75% to 25% by weight wherein the free monomers, dimers and oligomers of the petroleum and bio polymers are substantially reduced by devolatization and a third input consisting of at least one impact modifier, by example only, butyl acrylate methyl methacrylate and ethylene/n-butyl acrylate/glycidyl methacrylate (EnBAGMA) of 1% to 5% by weight and a fourth input color additive of 0.0001% to about 0.002% by weight that is added to shift the material from its natural yellow hew to a water blue hew.

In one embodiment a polymer composition comprising about 100% by weight of at least one bio-alloy, the bio-alloy comprising of at least of polymethyl methacrylate (PMMA) of 25% to 75% by weight and amorphous Polylactic Acid (PLA) of 75% to 25% by weight wherein the free monomers, dimers and oligomers of the petroleum and bio polymers are substantially reduced by devolatization, a third input consisting of at least one impact modifier, by example only, butyl acrylate methyl methacrylate and ethylene/n-butyl acrylate/glycidyl methacrylate (EnBAGMA) of 0.5% to 5% by weight by weight and a fifth input color additive of 0.0001% to about 0.002% by weight that is added to shift the material from its natural yellow hew to a water blue hew where applicable.

In one embodiment a polymer composition comprising about 100% by weight of at least one bio-alloy, the bio-alloy comprising of at least one petroleum polymer of 25 to 75% by weight and an amorphous biopolymer of 75% to 25% by weight wherein the free monomers, dimers and oligomers of the petroleum and biopolymers are substantially reduced by devolatization, a third input consisting of ethylene vinyl acetate (EVA) for a first impact modifier of 1% to 10% by weight, a fourth input consisting of a second impact modifier, by example only, butyl acrylate methyl methacrylate or ethylene/n-butyl acrylate/glycidyl methacrylate (EnBAGMA) of 0.5% to 5% by weight may be may be a by weight and a fifth input where applicable, color additive of 0.0001% to about 0.002% by weight to shift the material from its natural yellow hew to a water blue hew where applicable.

In one embodiment a polymer composition having improved heat deflection temperature comprising about 100% by weight of at least one bio-alloy, the bio-alloy comprising of PMMA of 25% to 75% by weight and a crystalline or amorphous PLA of 75% to 25% by weight wherein the free monomers, dimers and oligomers of the petroleum and bio polymers are substantially reduced by devolatization, for a first impact modifier of 1% to 10% by weight, a fourth input consisting of a second impact modifier, by example only, butyl acrylate methyl methacrylate or ethylene/n-butyl acrylate/glycidyl methacrylate (EnBAGMA) of 0.5% to 5% by weight and a fifth input comprised of a at least one nucleating agent that may be, by example only, an aromatic sulfonate based or ethylene bis-steramide (EBS) of 0.5% to 1% by weight and alternatively or in conjunction with a second nucleating agent, talc of 3% to 10% by weight.

In one embodiment, a polyhydroxyalkanoate (PHA) including polyhydroxybutyrate, polyhydroxyvalerate and copolymers thereof, may be added as an impact modifier.

In some embodiments, the at least one petroleum-based polymer may be comprised of a blend of petroleum-based polymers.

In one embodiment a perceived clear polymer composition comprising about 100% by weight of at least one bio-alloy, the bio-alloy comprising of PMMA of 25% to 75% by weight, a biopolymer composition comprising about 100% by weight an amorphous PLA polymer of 96% to 85% by weight, a second amorphous polyhydroxyalkanoic (PHA) polymer of 4% to 15% by weight comprising 75% to 25% of polymer composition, wherein the free monomers, dimers and oligomers of the petroleum and bio polymers are substantially reduced by devolatization and where applicable, a fourth input color additive of 0.0001% to about 0.002% by weight that is added to shift the material from its natural yellow hew to a water blue hew.

In one embodiment a polymer composition comprising about 100% by weight of at least one bio-alloy, the bio-alloy comprising polymethyl methacrylate of 25 to 75% by weight and an amorphous polylactic acid polymer of 75% to 25% by weight wherein the free monomers, dimers and oligomers of the petroleum and bio polymer are substantially reduced by devolatization and a third input consisting of an impact modifier of 1% to 15% by weight having a refractive index compatible with the petroleum and bio-based polymers for purpose of improving % Transmission and reduced Haze and a fourth input color additive 0.0001% to about 0.002% by weight that is added to shift the material from its natural yellow hew to a water blue hew.

In one embodiment a polymer composition having improved heat deflection temperature comprising about 100% by weight of at least one bio-alloy, the bio-alloy comprising polymethyl methacrylate of 25% to 75% by weight and a crystalline polylactic acid polymer of 75% to 25% by weight wherein the free monomers, dimers and oligomers of the petroleum and bio polymers are substantially reduced by devolatization, a third input impact modifier consisting of a copolymer of ABS and rubber of 1% to 15% by weight and a fourth input being a nucleating agent that may be talc of 5% to 15% by weight, an aromatic sulfonate based or EBS nucleating agent of 0.5% to 1% to accelerate the crystallization of the crystalline bio-polymer to create a natural colored material that may be further colored by addition of color additives.

In one embodiment a polymer composition having improved heat deflection temperature comprising about 100% by weight of at least one bio-alloy, the bio-alloy comprising of ABS of 25% to 75% by weight, an crystalline polylactic acid polymer of 75% to 25% by weight, a third input consisting of an impact modifier a copolymer of ABS and rubber of 1% to 15% by weight, an aromatic sulfonate based nucleating agent of 0.5% to 1% to accelerate the crystallization of the crystalline bio-polymer to create a natural colored material that may be further colored to as necessary by addition of color additives.

In another aspect, the present invention relates to a polymer composition comprising about 100% by weight of at least one bio-alloy, the bio-alloy comprising about 25% to about 75% by weight of at least one amorphous polylactic acid based biopolymer, about 75% to about 25% by weight of at least one hybrid biopolymer having same molecular structure as polymethyl (meth)acrylate petroleum-based polymer, about 1% to about 15% of at least one impact modifier, and about 0.0001% to about 0.002% of at least one optical additive.

In one embodiment a polymer composition comprising about 100% by weight of at least one bio-alloy, the bio-alloy comprising of at least one hybrid biopolymer of 75% to about 25% by weight having same molecular structure as polymethyl (meth)acrylate petroleum-based polymer, an amorphous biopolymer of 25% to 75% by weight, a third input consisting of ethylene vinyl acetate (EVA) for a first impact modifier of 1% to 10% by weight, a fourth input consisting of a second impact modifier, by example only, butyl acrylate methyl methacrylate or ethylene/n-butyl acrylate/glycidyl methacrylate (EnBAGMA) of 0.5% to 5% by weight and a fifth input where applicable, color additive of 0.0001% to about 0.002% by weight to shift the material from its natural yellow hew to a water blue hew where applicable.

In another aspect, the present invention relates to a polymer composition comprising about 100% by weight of at least one bio-alloy, the bio-alloy comprising about 25% to about 75% by weight of at least one amorphous and crystalline polylactic acid based biopolymer, about 75% to about 25% by weight of at least one hybrid bio polymer having same molecular structure as a polyester petroleum-based polymer and about 1% to about 10% of at least impact modifier.

In one embodiment a polymer composition having improved heat deflection temperature comprising about 100% by weight of at least one bio-alloy, the bio-alloy comprising of at least one hybrid biopolymer having same molecular structure as polymethyl (meth)acrylate petroleum-based polymer, an amorphous biopolymer of 75% to 25% by weight and a crystalline polylactic acid polymer of 25% to 75% by weight, a third input impact modifier consisting of a copolymer of ABS and rubber of 1% to 15% by weight and a fourth input being a nucleating agent that may be talc of 5% to 15% by weight, an aromatic sulfonate based or EBS nucleating agent of 0.5% to 1% to accelerate the crystallization of the crystalline bio-polymer to create a natural colored material that may be further colored by addition of color additives.

The compositions embodied herein are based on 100% by weight and thus, the polymer amounts may be reduced accordingly upon addition of any optical or other additive to achieve the desired physical, mechanical, thermal properties and haze and % Transmission when applicable.

The resultant bio-alloy compositions can be used for forming articles by various means, including, without limitation, by means of profile extrusion, sheet extrusion, film extrusion, for molding articles by means of, for example, injection molding, blow molding, compression molding and roto-molding and 3D printing.

The percentage of optical additive used to produce a given bio-alloy with improved optical characteristics is dependent on the color and optical characteristics of the resultant compounded bio-alloy without the optical additive.

For example, the percentage by weight of the biopolymer in the bio-alloy may impact the percentage of optical additive required to achieve a material with higher perceived clarity.

For example, certain virgin grades of NatureWorks Ingeo™ PLA have a yellow index (YI) that will vary from grade to grade and from lot to lot within a grade which affects light transmission and haze, i.e. clarity, which impacts the percentage by weight of dye required to achieve the desired results in the finished composition.

The optical additive may be any additive that alters the perceived color and clarity of the polymer composition as discussed above. For example, it may be a dye, preferably a solvent based dye, and is preferably blue or violet in color. An example of a commercially available optical additive for use herein is Keyplast part number Violet IRS.

The present invention allows for the addition of none or of very small amounts of optical additive to achieve a more perceived clear material, for example, about 0.0001% to about 0.002% of the resultant polymer composition. The optical additive may be compounded into a masterbatch for ease of feeding when compounding a clear bio-alloy.

The present invention also allows for the use of little or no optical additive to shift the yellowness index towards the blue which is a negative number on Lab scale.

The bio-alloy compositions may include any other suitable additives known in the art including, but not limited to, stabilizers, such as antimicrobials, UV inhibitors, antioxidants, antiozonants, nucleating agents, compatibilizing agents, impact modifiers, other colorants or dyes, plasticizers, tackifiers, reinforcing additives such as glass beads, bubbles spheres, fire retardants, etc., and any combination thereof. Furthermore, additives must be judiciously chosen to not adversely impact the clarity and haze of the resultant bio-alloy when the desired material characteristics require the bio-alloy to have a perceived optical clarity.

### EXAMPLES

The following examples incorporate a single biopolymer compounded individually with two different acrylics from two different manufacturers. The acrylics are of similar physical properties and melt flow index (MFI) and are of similar grade but of a different quality. The quality was determined using a Thermal Desorption-GCMS (TD) that measured free monomers, dimers and oligomers in the resins and Pyrolysis-GCMS(PY) that measured monomer bound in the polymeric backbone.

Table 1 illustrates the difference in free monomer(s) in the two resins. Methylacrylate (MA) is expressed as a percentage of the signal of the methylmethacrylate (MMA). The “Area %” does not imply that there is a given weight percent of the monomer present, rather only relative amounts. “ND” in the table indicates the compound was not detected. It should be noted there is a large difference in quality between the selected acrylics, which bears on the economics and commercial viability of the bio-alloy utilizing each acrylic. Table 1 below is employed to illustrate the reduction of free monomers, dimers and oligomers.

Thermal Desorption-GCMS (TD) uses a temperature range adequate to cause melt and off-gassing to measure volatiles, in this case the free monomers, dimers, oligomers. Pyrolysis-GCMS(PY) utilizes sufficient heat to break the backbone of the polymer to determine its constituent components.

TABLE 1
Analysis of LG IF850 and Altuglas V920

| | | RT | Area | Area % |
|---|---|---|---|---|
| IF 850 TD #1 | MA | 3.153 | 59812 | 6.71 |
| | MMA | 3.903 | 891282 | 100 |
| IF 850 PY #1 | MA | 3.145 | 3039615 | 5.78 |
| | MMA | 3.936 | 52565923 | 100 |
| IF 850 TD #2 | MA | 3.178 | 77860 | 7.14 |
| | MMA | 3.92 | 1091083 | 100 |
| IF 850 PY #2 | MA | 3.145 | 3617554 | 5.65 |
| | MMA | 3.945 | 63991183 | 100 |
| IF 850 TD #3 | MA | 3.178 | 40322 | 8.05 |
| | MMA | 3.92 | 500927 | 100 |
| IF 850 PY #3 | MA | 3.145 | 1618266 | 5.73 |
| | MMA | 3.92 | 28242124 | 100 |
| V920 TD #1 | MA | | ND | |
| | MMA | 3.936 | 3344779 | 100 |
| V920 PY #1 | MA | 3.128 | 143413 | 0.21 |
| | MMA | 3.945 | 67760786 | 100 |
| V920 TD #2 | MA | | ND | |
| | MMA | 3.936 | 4551765 | 100 |
| V920 PY #2 | MA | 3.162 | 198368 | 0.20 |
| | MMA | 3.978 | 96789583 | 100 |
| V920 TD #3 | MA | | ND | |
| | MMA | 3.945 | 5731303 | 100 |
| V920 PY #3 | MA | 3.137 | 251373 | 0.22 |
| | MMA | 3.978 | 115418128 | 100 |

Compounding Comparitive Bio-Alloys with Optical Additive

The following comparative example materials were produced on a Coperion zsk 30mm co-rotating, intermeshing compounding extruder. The screw design is conventional and includes four basic unit operations: (1) a melt zone to convert the resin to a molten state; (2) a distributive mixing zone to homogenize the molten resins and their additives; (3) a de-volatilization zone to remove any volatiles; and (4) a pumping zone to meter and pump the melt through the die.

The compounded exemplary materials were pelletized for further processing such as injection molding. Screw design may be varied depending on the polymeric materials and additives, as well as the batch size, equipment size, etc. When selecting a screw design, differences in the melting temperature of the materials and sensitivity to heat degradation, as well as shear and dwell time sensitivity of each polymer material should be taken into account to avoid degradation of the polymers. The biopolymers are typically more sensitive to degradation caused by these parameters.

### Example 1

### Altuglas V920 PMMA

A PLA/PMMA Alloy with optical additive was compounded on a Coperion zsk 30 mm co-rotating, intermeshing compounding extruder. The composition included 25% by weight Altuglas V920 PMMA, 67% by weight NatureWorks Ingeo 4060D PLA and 8% by weight Keyplast Violet IRS optical additive in the master batch equating to an actual 0.0008% by weight optical additive in the finished composition.

### Example 2

### LG IF 850 Acrylic PMMA

A PLA/PMMA alloy with optical additive was compounded on a zks 30 mm co-rotating, intermeshing compounding extruder. The composition included 25% by weight LG IF 850 Acrylic PMMA, 67% by weight NatureWorks® Ingeo 4060D PLA and 8% by weight Keyplast Violet IRS optical additive in the master batch equating to an actual 0.0008% by weight optical additive in the finished composition.

Each of the compounded bio-alloy exemplary materials 1 and 2 were dried at 40° C. for 4 hours and then injection molded on a 85 ton Van Dorn injection molding machine using ASTM Sample Family Mold to create disks, strips and dog-bones for physical characterization on an Instron. Other laboratory testing including optical characterization was performed on a Macbeth Color Eye model CE-7000. Physical and mechanical characteristics for each of the compositions are as follows:

TABLE 2
Physical & Mechanical Properties of Inputs

| | | Arkema V920 Acrylic | | | | NatureWorks | |
|---|---|---|---|---|---|---|---|
| Physical Properties | Test Standard | English | SI Metric | LG IF 850 Acrylic | | 4060D PLA | |
| Density | ASTM D792 | 1.20 g/cm3 | 1.20 g/cm3 | 1.19 g/cm3 | 1.19 g/cm3 | 1.25 g/cm3 | 1.25 g/cm3 |
| Melt Index (MFR) | ASTM D1238 | 7.7 g/10 min | 7.7 g/10 min | 12.3 g/10 min | 16.6 g/10 min | 16.6 g/10 min | 16.6 g/10 min |
| 230° C./2.160 kg | | | | | | | |
| Viscosity | ASTM E795 | 1796 lb/(ft s) | 2672 Pa-sec | 482 lb/(ft s) | 718 Pa-sec | 482 lb/(ft s) | 718 Pa-sec |
| Mechanical Properties | Test Standard | English | SI Metric | English | SI Metric | English | SI Metric |
| Ultimate Tensile | ASTM D638 | 9.2 ksi | 614 MPa | ksi | 70 MPa | 8.9 ksi | 61 MPa |
| Strength | | | | | | | |
| Tensile Modulus | ASTM D638 | 428 ksi | 2951 MPa | ksi | MPa | 509 ksi | 3509 MPa |
| Tensile Strain at Break | ASTM D638 | 9.1% | 9.1% | 13.0% | 13.0% | 3.0% | 3.0% |
| Notched Izod Impact | ASTM D256 | 3.4 ft-lb/inch | 182 J/m | .71 ft-lb/inch | 14.7 J/m | 2.5 ft-lb/inch | 134 J/m |
| Strength | | | | | | | |
| Flexural Modulus | ASTM D790 | 478 ksi | 3296 MPa | 478.6 ksi | 3304 MPa | 479 ksi | 3303 MPa |

TABLE 3
Physical & Mechanical Properties of Examples 1 & 2

| | | Compounding Method 1 Example 1 | | | | Compounding Method 1 Example 2 | |
|---|---|---|---|---|---|---|---|
| | | PLA 4060D (75%) + V920 (25%) | | | | PLA 4060D (75%) + LG IF 850 (25%) | |
| Physical Properties | Test Standard | English | | SI Metric | | English | SI Metric |
| Density | ASTM D792 | 1.25 | g/cm3 | 1.25 | g/cm3 | N/A g/cm3 | N/A g/cm3 |
| Melt Index (MFR) 230° C./2.160 kg | ASTM D1238 | 7.8 g/10 min | | 7.8 g/10 min | | N/A g/10 min | N/A g/10 min |
| Viscosity | ASTM E795 | 1001.7 | lb/(ft s) | 1490.7 | Pa-sec | lb/(ft s) | Pa-sec |
| Mechanical Properties | Test Standard | English | | SI Metric | | English | SI Metric |
| Ultimate Tensile Strength | ASTM D638 | 9.8 | ksi | 68 | Mpa | N/A ksi | N/A Mpa |
| Tensile Modulus | ASTM D638 | 519 | ksi | 3578 | Mpa | N/A ksi | N/A Mpa |
| Tensile Strain at Break | ASTM D638 | 9.30% | | 9.30% | | N/A % | N/A % |
| Notched Izod Impact Strength | ASTM D256 | 2.66 | ft-lb/inch | 142 | J/m | N/A ft-lb/inch | N/A J/m |
| Flexural Modulus | ASTM D790 | 509 | ksi | 3509 | Mpa | N/A ksi | N/A Mpa |

Note:
Data for Compounding Method 1 Example 2 is not available due to inability to injection mold ASTM sample parts for testing due to the low quality polymer material formed.

### Comparison of the Example 1 and Example 2 Mechanical and Physical Properties

As can be observed in Table 3 for Example 2, the physical and mechanical properties are not available. The resultant material would not injection mold due to sticking to the sprue and mold. No acceptable ASTM sample parts could be molded.

This failure led to analysis of the material by Thermal Desorption-GCMS (TD) and the discovery of differences in amounts of free monomer, dimer and oligomer within the raw materials specifically in the PMMA's.

TABLE 4
Optical Characteristics

| | | | Transmitted | | | | | | |
|---|---|---|---|---|---|---|---|---|---|
| | % Trans- | Correlated | HUNTER (Lab) | | | Whiteness | Yellowness | Yellowness | Yellowness |
| Material Description | mission | Haze | L | a | b | WI-ASTM | YI-D1925 | YI-E313 | YI-E313-73 |
| Virgin PLA (Natureworks) 4060D | 86.2 | 10.22 | 93.91 | −0.15 | 2.07 | 77.09 | 5.17 | 2.11 | 4.72 |
| Virgin PMMA (Arkema) V920 | 87.6 | 1.36 | 95.87 | −0.03 | 0.22 | 90.7 | 1.79 | −1.33 | 1.95 |
| Virgin PMMA (LG) IF-850 | 91.6 | 0.74 | 95.71 | −0.06 | 0.39 | 89.46 | 2.08 | −1.03 | 2.2 |
| Example #1 (V920 PMMA) | 81.5 | 16.15 | 88.65 | 1.15 | −0.99 | 83.62 | 0.36 | −2.8 | 0.05 |
| Example #2 (IF-850 PMMA) | 75.5 | 13.71 | 85.86 | 1.9 | −2.97 | 88.27 | −3.09 | −6.32 | −3.23 |

Note:
The results are based on Hunter Lab values.
ASTM E1348-11 Standard Test Method for Transmittance and Color by Spectrophotometry Using Hemispherical Geometry
% Transmission, Specular Component Included, UV Included, Color Eye 7000 Color Eye QC

As per Table 4 the yellowness index, found in column 8, the closer the value gets to 0.0, the better the perceived color. Furthermore, according to Table 4 , Example #1 had better yellow index, %Transmission and lower haze than that of Example #2.

TABLE 5
Thermal Desorption (td) Analysis of Examples 1 & 2

| | |
|---|---|
| Thermal description from 100-200 C., 20 C./min, 3 min hold, | |
| cryo-focused | |
| Flash pyrolysis at 550 C., 0.5 min, cryo-focused | |
| Formula Example 2: PLA 4060D (74.9999%)/IF850 (25%)/Color | Formula 1 Example 1: PLA 4060D (74.9999%)/ |
| Additive 0.0001% | V920 (25%)/Color Additive 0.0001% |
| Example 2: id# 13127007 | Example 1 id# 140722014 |
| Thermal Desorption from 100-200 C., 20 min, 3 min hold, cryo-focused | |

| | | | | Methyl | Methyl | PLA |
|---|---|---|---|---|---|---|
| Sample ID | | Test | Acetaldehyde | Acrylate | Methacrylate | Dimers |
| 13127007 | Example 2 | td | 1680000 | 253000 | 4495000 | 3075000 |
| 140722114 | Example 1 | td | 0 | 0 | 156000 | 0 |

Note:
All data is unnormalized and represents ion count from the column

### Material Comparative Analysis

Table 5 shows the effect of de-valorization on the amount of acrylate monomers in the resulting bio-alloy (Example 1 #13127007 and Example 2 #1140722014) as compared to neat acrylics as shown in Tables 1 determined by TD-GCMS.

As can be seen from Table 5, there was no detectable Acetaldehyde and Methyl Acrylate monomers and low Methyl Methacrylate present in the bio-alloy Example 1. Example 2 showed reduced free monomers, however residual Methyl Acrylate and Methyl Methacrylate free monomers were still at an elevated level which negatively impacted the material's post compounding conversion by injection molding of ASTM samples. It is illustrated by thermal desorption the importance of de-valorization and its impact on reducing or removing residual free monomers, dimers and oligomers and the negative impact when there is too much free monomers, dimers and other oligomers.

### Example Compositions

Table 6 provides the baseline properties of virgin acrylic and PLA and that of a bio-alloy composition.

TABLE 6

| | | | Material Designation: I47994-43 | | | |
|---|---|---|---|---|---|---|
| | | | ARCbio3006 PLA 4060D (51.2%) | | | |
| | Material Designation: Chi Mei | | ChiMei 205 (40%) | | Material Designation: | |
| | product C-205 | | PHA M4100 (4.8%) MB VLT0001 (4%) | | PLA 4060D (51.2%) | |
| | Properties & Average | | Properties & Average | | Properties & Average | |
| | Values of Injection Molded Parts | | Values of Injection Molded Parts | | Values of Injection Molded Parts | |
| Test Standard | Physical Properties | English | Physical Properties | English | Physical Properties | English |
| ASTM D792 | Specific Gravity | 1.19 g/cm3 | Specific Gravity | 1.243 g/cm3 | Specific Gravity | 1.244 g/cm3 |
| ASTM D1238 | Melt Index (MFR) | 1.7 g/10 min | Melt Index (MFR) | 4.10 g/10 min | Melt Index (MFR) | 10 g/10 min |
| | 230° C./3.80 kg | | 210° C./2.160 kg | | 210° C./2.160 kg | |
| NA | Color | NA | Color | Clear | Color | NA |
| | | | Glass Transition Temp | 138° F. | | |
| Test Standard | Mechanical Properties | English | Mechanical Properties | English | Mechanical Properties | English |
| ASTM D638 | Ultimate Tensile Strength | 10.3 ksi | Ultimate Tensile Strength | 10.04 ksi | Ultimate Tensile Strength | 8.9 ksi |
| ASTM D638 | Tensile Modulus | 419 ksi | Tensile Modulus | 539.7 ksi | Tensile Modulus | 509 ksi |
| ASTM D638 | Tensile Strain at Break | 7.3% | Tensile Strain at Break | 3.5% | Tensile Strain at Break | 3.0% |
| ASTM D256 | Notched Izod Impact | 3.2 ft-lb/inch | Notched Izod Impact | 2.80 ft-lb/inch | Notched Izod Impact | 2.5 ft-lb/inch |
| | Strength | | Strength | | Strength | |
| ASTM D5420 | Gardner Impact Strength | 0.17 lbf | Gardner Impact Strength | 0.17 lbf | Gardner Impact Strength | 0.22 lbf |
| ASTM D790 | Flexural Modulus | 487 ksi | Flexural Modulus | 485.17 ksi | Flexural Modulus | 479 ksi |
| | Thermal Properties | English | Thermal Properties | English | Thermal Properties | English |
| ASTM D1525 | Vicat Point @ 50N @ | 212° F. | Vicat Point @ 50N @ | 150° F./66° C. | Vicat Point @ 50N @ | |
| | 120° C. | | 120° C. | | 120° C. | |
| ASTM D648 | Deflection Temperature | 235° F. | Deflection Temperature | 133° F./56° C. | Deflection Temperature | |
| | @ 264 psi | | @ 264 psi | | @ 264 psi | |
| ASTM E794 | Glass Transition Temp | | Glass Transition Temp | 149° F./65° C. | Glass Transition Temp | 140° F./60° C. |

Each of the materials accompanying compositions were subjected to a variety of analytical tests to establish differences in material characteristics, and additional post compounding processing such as injection molding and sheet extrusion.

These examples illustrate improved impact strength, heat distortion temperature and clarity over virgin PLA and that is similar to that of general purpose PETG.

Composition 1: Clear Color Corrected Bio-Alloy

| | PLA | Chi Mei | Sukano | |
|---|---|---|---|---|
| Lot# | 4060D | 205 | 633 | VLT MB |
| A15118077 | 33% | 60% | 5% | 2% |

| Properties | Mean | Unit | ASTM |
|---|---|---|---|
| True Density | 1.1401 | g/cm3 | ASTM D792 |
| Melt Index (MFR) 230° C./3.8 kg | 6.25 | g/10 min | ASTM D1238 |
| Ultimate Tensile Strength 2″ | 11.35 | ksi | ASTM D638 |
| Tensile Modulus 2″ | 511.2 | ksi | ASTM D638 |
| Tensile Strain at Break 2″ | 7.3 | % | ASTM D638 |
| Flexural Modulus fast | 495.19 | ksi | ASTM D790 |
| Notched Izod Impact Strength | 0.33 | ft-lb/inch | ASTM D256 |
| Meth. A | | | |
| Notched Izod Impact Strength | 3.25 | ft-lb/inch | ASTM D256 |
| Meth. E | | | |
| Un-notched Izod | 4.85 | ft-lb/inch | ASTM D4812 |
| Glass Transition Temp | 70.87 | ° C. | ASTM E794 |
| Deflection Temperature @ 66 psi | 63.13 | ° C. | ASTM D648 |
| Deflection Temperature @ 66 psi | 145.64 | ° F. | ASTM D649 |
| VICAT 10N | 84.17 | ° C. | ASTM 1525 |
| VICAT 10N | 183.5 | ° F. | ASTM 1525 |
| % Transmission-Strip | 90 | | |
| Correlated Haze-Strip | 10.1 | | |

Composition 2: Clear Color Corrected Bio-Alloy

| | PLA | Chi Mei | Sukano | |
|---|---|---|---|---|
| Lot# | 4060D | 205 | 633 | VLT MB |
| A15118077 | 33% | 60% | 5% | 2% |

| Properties | Mean | Unit | ASTM |
|---|---|---|---|
| True Density | 1.1401 | g/cm3 | ASTM D792 |
| Melt Index (MFR) 230° C./3.8 kg | 6.25 | g/10 min | ASTM D1238 |
| Ultimate Tensile Strength 2″ | 11.35 | ksi | ASTM D638 |
| Tensile Modulus 2″ | 511.2 | ksi | ASTM D638 |
| Tensile Strain at Break 2″ | 7.3 | % | ASTM D638 |
| Flexural Modulus fast | 495.19 | ksi | ASTM D790 |
| Notched Izod Impact Strength | 0.33 | ft-lb/inch | ASTM D256 |
| Meth. A | | | |
| Notched Izod Impact Strength | 3.25 | ft-lb/inch | ASTM D256 |
| Meth. E | | | |
| Un-notched Izod | 4.85 | ft-lb/inch | ASTM D4812 |
| Glass Transition Temp | 70.87 | ° C. | ASTM E794 |
| Deflection Temperature @ 66 psi | 63.13 | ° C. | ASTM D648 |
| Deflection Temperature @ 66 psi | 145.64 | ° F. | ASTM D649 |
| VICAT 10N | 84.17 | ° C. | ASTM 1525 |
| VICAT 10N | 183.5 | ° F. | ASTM 1525 |
| % Transmission-Strip | 90 | | |
| Correlated Haze-Strip | 10.1 | | |

Composition 3: Clear Color Corrected Bio-Alloy

| | | PLA | Chi Mei | Dow | | |
|---|---|---|---|---|---|---|
| Lot# | Index | 4060D | 205 | BPM 515 | EVA | MB VLT 0001 |
| C15240804 | 4 | 32.5% | 62% | 0.5% | 3% | 2% |

| Properties | Mean | Unit | ASTM |
|---|---|---|---|
| True Density | 1.2023 | g/cm3 | ASTM D792 |
| Melt Index (MFR) 230° C./2.160 kg | 5.95 | g/10 min | ASTM D1238 |
| Ultimate Tensile Strength 2″ | 11.57 | ksi | ASTM D638 |
| Tensile Modulus 2″ | 508.6 | ksi | ASTM D638 |
| Tensile Strain at Break 2″ | 12.6 | % | ASTM D638 |
| Flexural Modulus (fast) | 494.54 | ksi | ASTM D790 |
| Notched Izod Impact Strength (A) | 0.54 | ft-lb/inch | ASTM D256 Method A |
| Notched Izod Impact Strength (E) | 5.16 | ft-lb/inch | ASTM D256 Method E |
| Un-notched Izod | 7.58 | ft-lb/inch | ASTM D4812 |
| Glass Transition Temp | 73.1 | ° C. | ASTM E794 |
| Deflection Temperature @ 66 psi (C.) | 67.80 | ° C. | ASTM D648 |
| Deflection Temperature @ 66 psi (F.) | 154.04 | ° F. | ASTM D648 |
| Vicat 10N C. | 88.43 | ° C. | ASTM 1525 |
| Vicat 10N F. | 191.18 | ° F. | ASTM 1525 |
| % Transmission-Strip | 91.8 | % | |
| Correlated Haze-Strip | 23.71 | % | |

Composition 4: White/Natural Bio-Alloy

| | PLA | | Blendex | |
|---|---|---|---|---|
| Lot# | 2003D | Chi Mei 205 | 338 | Tiona TiO2 |
| A15098077 | 35% | 44% | 10% | 6% |

| Properties | Mean | Unit | ASTM |
|---|---|---|---|
| True Density | 1.2686 | g/cm3 | ASTM D792 |
| Melt Index (MFR) 230° C./ 3.8 kg | 2.61 | g/10 min | ASTM D1238 |
| Ultimate Tensile Strength 2″/Min. | 9.29 | ksi | ASTM D638 |
| Ultimate Tensile Strength 0.2″/Min. | 8.48 | | ASTM D638 |
| Tensile Modulus 2″/Min. | 574.9 | ksi | ASTM D638 |
| Tensile Modulus 0.2″/Min. | 544.7 | | ASTM D638 |
| Tensile Strain at Break 2″/Min. | 11 | % | ASTM D638 |
| Tensile Strain at Break 0.2″/Min. | 21.2 | | ASTM D638 |
| Flexural Modulus Slow | 508.23 | ksi | ASTM D790 |
| Flexural Modulus Fast | 536.13 | | ASTM D790 |
| Notched Izod Impact Strength Meth. A | 1.04 | ft-lb/inch | ASTM D256 |
| Notched Izod Impact Strength Meth. E | 5.84 | ft-lb/inch | ASTM D256 |
| Un-notched Izod | 10.36 | ft-lb/inch | ASTM D4812 |
| Glass Transition Temp | 72 | ° C. | ASTM E794 |
| Deflection Temperature @ 66 psi (° C.) | 65.2 | ° C. | ASTM D648 |
| Deflection Temperature @ 66 psi (° F.) | 149.36 | ° F. | ASTM D648 |
| VICAT 10N (° C.) | 86.63333333 | ° C. | ASTM D1525 |
| VICAT 10N (° F.) | 187.94 | ° F. | ASTM D1525 |

The invention is also directed to a polymer composition consisting of about 99.9999% to about 99.998% by weight of a bio-alloy, the bio-alloy consisting of about 25% to about 75% by weight of at least one biopolymer and about 75% to about 25% by weight of at least one petroleum-based polymer; and about 0.0001% to about 0.002% by weight of at least one optical additive. Desirably, the composition consists about 40% to about 60% by weight of at least one biopolymer and about 60% to about 40% by weight of at least one petroleum-based polymer. Optionally, the at least one biopolymer consists of about 5% to 95% by weight of a first biopolymer and about 95% to about 5% by weight of a second biopolymer. Desirably, the yellowness index of the polymer composition as determined by the b value on the Lab scale is between about 0 and about −0.20. Desirably, the b value of the polymer composition on the Lab scale is between about −0.02 and −0.15. Desirably, the light transmission of the polymer composition is about 85% to about 89%. Desirably, the correlated haze of the polymer composition is about is 5% to 20%. Desirably, the free monomer, dimer or oligomer in the polymer composition is present in an amount of less than about 0.01%, by weight, and more desirably, less than 0.003% by weight, and even more desirably, less than 0.002% by weight.

The biopolymer may comprise or consist of a poly(lactic acid) based polymer. The at least one petroleum-based polymer may comprise or consist of polymethyl(meth)acrylate.

Desirably, the optical additive comprises or consists of a blue or violet dye.

The invention is also directed to a polymer composition manufactured from about 25% to about 75% by weight of at least one biopolymer and about 75% to about 25% by weight of at least one petroleum-based polymer; and about 0.0001% to about 0.002% by weight of at least one optical additive. Additional additives may be provided. Desirably, the composition is manufactured from about 40% to about 60% by weight of at least one biopolymer and about 60% to about 40% by weight of at least one petroleum-based polymer. Desirably, free monomer, dimer or oligomer in the bio-alloy is present in an amount of less than about 0.01%, by weight, and more desirably, less than 0.003% by weight, and even more desirably, less than 0.002% by weight.

A description of some of the embodiments of methods of making the polymer compositions, compositions of bio alloys and their physical, mechanical and thermal properties is disclosed herein and is contained in one or more of the following statements:

A method of compounding bio-alloys comprising providing a first input of at least one petroleum-based polymer, providing a second input including at least one biopolymer, blending the petroleum-based polymer and the biopolymer so as to produce a blended compound and devolatilizing the blended compound and simultaneously adding optical or other additives.

The at least once devolatilizing of the blended compound desirably is accomplished by applying a vacuum thereto.

The method of statement 1 wherein first and second inputs are blended using a twin screw co-rotating intermeshing compounding extruder.

The method of any of statements 1 and 2 wherein the first and second inputs are provided in a ratio ranging from 1:3 to 3:1.

The method of any of statements 1-3 wherein the first and second inputs are provided in a ratio ranging from 1:3 to 1:4.

The method of any of statements 1-4 further comprising adding a second biopolymer to the second input.

The invention is also directed, in other embodiments, to any of the polymer compositions disclosed herein, and methods of making the same, where, in place of the petroleum-based polymers, one or more polymers or blends which are not formed from petroleum, petroleum by-products, petroleum-derived monomers or petroleum-derived feedstocks but which are of the same chemical composition as a petroleum-based polymer, are used. For example, such a polymer composition could be made using a plant-based polyethylene terephthalate rather than a petroleum-based polyethylene terephthalate.

To that end, the invention is directed in or more embodiments, to a polymer composition comprising about 25% to about 75% by weight of at least one biopolymer and about 75% to about 25% by weight of at least one polymer which is not petroleum-based but which the same chemical composition as a petroleum-based polymer, and about 0.0001% to about 0.002% by weight of at least one optical additive.

The invention is also directed to a polymer composition comprising a biopolymer and a polymer which is not petroleum-based but which has the same chemical composition as a petroleum-based polymer, the biopolymer present in an amount ranging from 25% to about 75% by weight, the polymer which is not petroleum-based present in an amount ranging from 75% to about 25% by weight, and an optional optical additive. The polymer composition may have a yellowness index as determined by the b value on the Lab scale between about 0 and about −0.20 and/or the polymer composition may have a b value on the Lab scale of between about −0.02 and −0.15, and/or the polymer composition may have a light transmission of about 70% to about 85%. The polymer composition may comprise about 0.0001% to about 0.002% by weight of the optical additive.

The invention may be embodied in other forms without departing from the spirit or novel characteristics thereof. The exemplary embodiments disclosed in this application are to be considered in all respects as illustrative and not limitative. The scope of the invention is indicated by the appended claims rather than by the foregoing description; and all changes which come within the meaning and range of equivalency of the claims are intended to be embraced therein. For the purposes of this disclosure, the term “comprising” means “including, but not limited to”.

1. A polymer composition having improved heat deflection temperature and perceived optical clarity comprising about 100% by weight of at least one bio-alloy, the bio-alloy comprising at least petroleum-based polymer of about 75% to about 25% by weight, an amorphous biopolymer of about 25% to about 75% by weight, and a color additive to increase optical clarity.

2. The polymer composition of claim 1 further including a color additive of about 0.0001% to about 0.002% by weight to shift the material from its natural yellow hue to a water blue hue.

3. The polymer composition of claim 2 wherein the color additive is a blue or violet dye.

4. The polymer composition of claim 1 further including a first impact modifier consisting of ethylene vinyl acetate (EVA) of about 1% to about 10% by weight, and a second impact modifier selected from the group consisting of butyl acrylate methyl methacrylate and ethylene/n-butyl acrylate/glycidyl methacrylate (EnBAGMA), at about 0.5% to about 5% by weight.

5. The polymer composition of claim 1 further including an impact modifier comprising a butyl acrylate methyl methacrylate core shell impact modifier of about 1% to about 5% by weight.

6. The polymer composition of claim 1 wherein the petroleum-based polymer is polymethyl methacrylate (PMMA).

7. The polymer composition of claim 1 wherein the biopolymer is amorphous polylactic acid (PLA).

8. The polymer composition of claim 1 wherein the petroleum-based polymer is polymethyl methacrylate (PMMA) and the biopolymer is amorphous polylactic acid (PLA).

9. A polymer composition having improved heat deflection temperature and perceived optical clarity comprising about 100% by weight of at least one bio-alloy, the bio-alloy comprising at least one hybrid biopolymer of about 75% to about 25%, an amorphous biopolymer of about 25% to about 75% by weight, and a color additive of about 0.0001% to about 0.002% by weight to shift the material from its natural yellow hue to a water blue hue.

10. The polymer composition of claim 9 wherein the hybrid biopolymer has the same molecular structure as polymethyl (meth)acrylate petroleum-based polymer.

11. The polymer composition of claim 9 wherein the biopolymer is amorphous polylactic acid (PLA).

12. The polymer composition of claim 9 wherein the hybrid biopolymer has the same molecular structure as polymethyl (meth)acrylate (PMMA) petroleum-based polymer and the biopolymer is amorphous polylactic acid (PLA).

13. The polymer composition of claim 9 wherein the color additive is a blue or violet dye.

14. The polymer composition of claim 9 further including a second additive consisting of an impact modifier consisting of ethylene vinyl acetate (EVA) of about 1% to about 10% by weight, and a third additive consisting of an impact modifier selected from the group consisting of butyl acrylate methyl methacrylate and ethylene/n-butyl acrylate/glycidyl methacrylate (EnBAGMA), at about 0.5% to about 5% by weight.

15. A polymer composition having an improved heat deflection temperature comprising about 100% by weight of at least one bio-alloy, the bio-alloy comprising:
at least one petroleum-based polymer of about 75% to about 25% by weight, at least one crystalline biopolymer of about 25% to 75% by weight, and a nucleating agent selected from the group consisting of talc of about 5% to about 15% by weight, an aromatic sulfonate-based nucleating agent or an ethylene bis-steramide (EBS) nucleating agent of about 0.5% to about 1% by weight, or a combination of said nucleating agents to accelerate crystallization of the crystalline bio-polymer to create a natural colored material.

16. The polymer composition of claim 15 further including an impact modifier consisting of a copolymer of ABS and rubber of about 1% to about 15% by weight.

17. The polymer composition of claim 15 wherein said nucleating agent is talc.

18. The polymer composition of claim 15 wherein the petroleum-based polymer is polymethyl methacrylate (PMMA).

19. The polymer composition of claim 15 wherein the crystalline biopolymer is crystalline polylactic acid (PLA).

20. The polymer composition of claim 15 wherein the petroleum-based polymer is polymethyl methacrylate (PMMA) and the crystalline biopolymer is crystalline polylactic acid (PLA).
